(19) United States
(12) Patent Application Publication
(10) Pub. No.: US 2004/0175186 A1
(43) Pub. Date: Sep. 9, 2004

(54) Optical transmission module

(75) Inventor: Seiichiro Tabata, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/790,213

(22) Filed: Mar. 2, 2004

(30) Foreign Application Priority Data
Mar. 3, 2003 (JP) 2003-055659

(51) Int. Cl. H04B 10/12

(52) U.S. Cl. 398/141

(57) ABSTRACT

An optical transmission module has a laser diode, a photodiode, a binary-type DOE lens for 1.3 μm and a DOE lens for 1.55 μm in a package. An optical fiber is arranged so that its end surface faces the optical transmission module. The laser diode radiates light of wavelength 1.3 μm. The photodiode receives light of wavelength 1.55 μm. Both DOE lenses have diffraction action of mutually different diffraction orders for light of the two wavelengths. The optical axis passing from the laser diode to the optical fiber and the optical axis passing from the photodiode to the optical fiber are separated. The optical transmission module is compact and has a small number of components.

### BACKGROUND OF THE INVENTION

1. Field of the Invention

The present invention relates to an optical transmission module used in optical communication systems that use optical fibers.

2. Description of the Related Arts

In an optical communication system or optical communication network, for example FTTH (Fiber To The Home), bi-directional optical transmission is performed by a single fiber, so that an optical transmission module for transmitting light is built in optical subscriber line terminal apparatus.

For example, in a conventional optical transmission module disclosed in Japanese Laid-open Patent Publication No. 2000-180671, light of 1.3 μm radiated from a laser diode (LD) housed in a package for a laser diode is converged by a lens for the laser diode. After that, the light is made incident on the optical fiber after passing through a coupler having a wavelength-selecting filter in the end surface of the prism. On the other hand, light of 1.55 μm emitted from the optical fiber is reflected by a wavelength-selecting filter, converged by a lens for a photodiode, and detected by a photodiode (PD) housed in a package for the photodiode.

In another conventional optical transmission module disclosed in Japanese Laid-open Patent Publication No. 7-104154, during sending, a light beam radiated from a light-emitting element passes through a diffraction grating and is converged on an end surface of the optical fiber by a lens. On the other hand, during receiving, a received light beam emitted from an end surface of the optical fiber reaches a diffraction grating through a lens. Then the light beam is diffracted by the diffraction grating, and the diffracted beam of order +1 is converged on the optical detection surface of a light-receiving element.

In another conventional optical transmission module disclosed in Japanese Laid-open Patent Publication No. 7-261054, only the light beam of diffraction order 0 whose optical axis does not deflect from the incident light beam passes through a lens to become a light beam and is converged on an end surface of the optical fiber to be transmitted through the optical fiber. On the other hand, a light beam that was transmitted from another optical module and the like through the optical fiber and emitted from its end surface on reaching this optical module goes through the reverse optical path to pass the lens and reaches the diffraction grating. Then as in sending, the light beam is diffracted and produces several diffracted light beams. Among them, only the diffracted light beam of order +1 converges on the receiving surface of a light-receiving element disposed around the light-emitting element, and the received signal is detected.

In another conventional optical transmission module disclosed in Japanese Laid-open Patent Publication No. 3-106091, a photo detector is disposed at the place where the incident light from the outside is diffracted by a diffraction grating. In another conventional optical transmission module disclosed in Japanese Laid-open Patent Publication No. 9-325246, a coupling lens is arranged to optically connect the optical fiber and an integrated photo-electric/electric-photo converter.

However, there are several problems in the conventional optical transmission modules described above. It is necessary for the optical transmission module disclosed in Japanese Laid-open Patent. Publication No. 2000-180671 to be equipped with a laser diode package, a photodiode package, a lens for a laser diode, a lens for a photodiode, a coupler, an optical fiber and the like. Therefore, the number of optical components is large, so that production cost is high. Further, adjustment of optical axes between optical components is necessary, so that it takes hard work for the adjustment. Still further, the optical path bifurcates in perpendicular directions, so that the size of the optical transmission becomes large. In the optical transmission modules disclosed in Japanese Laid-open Patent Publications Nos. 7-104154, 7-261054, 3-106091 and 9-325246 described above, diffraction efficiency, particularly diffraction efficiency of order 1 for light of 1.3 μm is low.

### SUMMARY OF THE INVENTION

The object of the present invention is thus to solve these problems and to provide a compact optical transmission module having a small number of components.

An optical transmission module in accordance with the present invention sends and receives light transmitted bi-directionally through an optical fiber. The optical transmission module has a light source, a receiver section and a binary-type diffractive optical element with a staircase-shaped diffracting surface. The light source radiates light of a first wave length. The receiver section receives light of a second wavelength emitted from the optical fiber. The diffractive optical element has principal diffracting action of different diffraction orders on the light of the first wavelength and the light of second wavelength. In addition, the diffractive optical element separates the first optical axis passing from the light source to the optical fiber and the second optical axis passing from the receiver section to the optical fiber.

Because the optical transmission module uses the binary-type diffractive optical element with principal diffractive action of different diffraction orders for light of the first wavelength and light of the second wavelength, the diffraction efficiency becomes higher. Further, because the first optical axis passing from the light source to the optical fiber and the second optical axis passing from the receiver section to the optical fiber are separated, the number of the optical components becomes small, and the optical transmission module becomes compact.

### BRIEF DESCRIPTION OF THE DRAWINGS

Other objects and attainments together with a fuller understanding of the invention will become apparent and appreciated by referring to the following description and claims taken in conjunction with the accompanying drawings, in which like parts are designated by like reference numerals and in which:

FIG. 1 is a side view showing part of the cross-section of an optical transmission module in accordance with a first embodiment of the present invention;

FIGS. 2A, 2B and 2C are respectively cross-sectional elevation views of an ordinary lens, quinoform-type DOE lens, and binary-type DOE lens;

FIGS. 3A and 3B are respectively front views of a DOE lens for 1.3 μm and a DOE lens for 1.55 μm;

FIG. 4 is a drawing illustrating the definition of the step height of a binary-type diffraction grating;

FIGS. 5A and 5B are respectively graphs showing the relationship between the step height and diffraction efficiency of a DOE lens for 1.3 μm and a DOE lens for 1.55 μm having 6 binary steps;

FIGS. 6A and 6B are respectively graphs showing the relationship between the step height and diffraction efficiency of a DOE lens for 1.3 μm and a DOE lens for 1.55 μm having 7 binary steps;

FIGS. 7A and 7B are respectively graphs showing the relationship between the step height and diffraction efficiency of a DOE lens for 1.3 μm and a DOE lens for 1.55 μm having 5 binary steps;

FIG. 8 is a cross-sectional side view of an integrated DOE lens;

FIG. 9 is a schematic oblique sketch of an optical transmission module in accordance with a fifth embodiment;

FIG. 10 is a side view showing part of the cross-section of an optical transmission module in accordance with a fifth embodiment;

FIG. 11 is an oblique sketch of a wavelength-separating DOE;

FIG. 12 is a cross-sectional side view of an integrated lens of wavelength-separating DOEs;

FIG. 13 is a side view showing part of the cross-section of an optical transmission module in accordance with a seventh embodiment;

FIG. 14 is a front view of an eccentric non-spherical DOE lens for 1.3 μm;

FIG. 15 is a side view showing part of the cross-section of an optical transmission module in accordance with an eighth embodiment;

FIG. 16 is a side view showing part of the cross-section of an optical transmission module in accordance with a variant of the eighth embodiment;

FIG. 17 is a side view showing part of the cross-section of an optical transmission module in accordance with a ninth embodiment; and

FIG. 18 is a graph showing the relationship between the step height and diffraction efficiency of a DOE lens for dual wavelength having 8 binary steps.

### DETAILED DESCRIPTION OF THE PREFERRED EMBODIMENTS

Several embodiments of the present invention will be described in the following with reference to accompanying drawings. In the drawings, components common to different embodiments are labeled with the same reference numerals.

(First Embodiment)

FIG. 1 illustrates the construction of an optical transmission module in accordance with a first embodiment of the present invention. As shown in FIG. 1, in the optical transmission module, a laser diode (LD) 2, a photodiode (PD) 3, a DOE (diffractive optical element) lens 4 for 1.3 μm, and a DOE lens 5 for 1.55 μm are arranged in a package 1. An optical fiber 6 is placed so that its end surface should face the optical transmission module (DOE lens 5 for 1.55 μm). Laser diode 2 radiates (emits) light 7 of wavelength 1.3 μm, and photodiode 3 receives light 8 of wavelength 1.55 μm.

In this way, the optical transmission module in accordance with the first embodiment uses two kinds of DOE lenses 4 and 5 consisting in diffractive optical elements having wavelength selectivity in place of ordinary lenses and couplers. These DOE lenses 4 and 5 have lens action for light of a particular wavelength and acts as a parallel plane plate for light of a particular wavelength different from that wavelength. Specifically, the DOE lens 4 for 1.3 μm acts as a lens for light 7 of 1.3 μm, which is the oscillation wavelength of laser diode 2, and acts as a parallel plane plate for light 8 of 1.55 μm, which is the wavelength to be received by photodiode 3. On the other hand, the DOE lens 4 for 1.55 μm acts as a parallel plane plate for light 7 of 1.3 μm, which is the oscillation wavelength of laser diode 2, and acts as a lens for light 8 of 1.55 μm, which is the wavelength to be received by photodiode 3.

Laser diode 2 and photodiode 3 are placed at different positions on a substrate 9 in the same package 1. Light 7 of wavelength 1.3 μm radiated from laser diode 2 is converged by DOE lens 4 for 1.3 μm so that light 7 can be incident on optical fiber 6, which is placed at a later stage in the direction light 7 propagates. Light 7 of wavelength 1.3 μm is incident on DOE lens 5 for 1.55 μm after that but passes straight through DOE lens 5 to be incident on optical fiber 6, since DOE lens 5 acts as a parallel plane plate.

On the other hand, light 8 of wavelength 1.55 μm emitted from optical fiber 6 is first converged by DOE lens for 1.55 μm. The DOE lens 5 for 1.55 μm has eccentricity effects, so that light 8 of wavelength 1.55 μm is emitted from DOE lens 5 with an inclined optical axis. After that, the light of wavelength 1.55 μm is incident on DOE lens 4 for 1.3 μm but passes straight through DOE lens 4 for 1.3 μm to be incident on photodiode 3, since DOE lens 4 for 1.3 μm acts as a parallel plane plate.

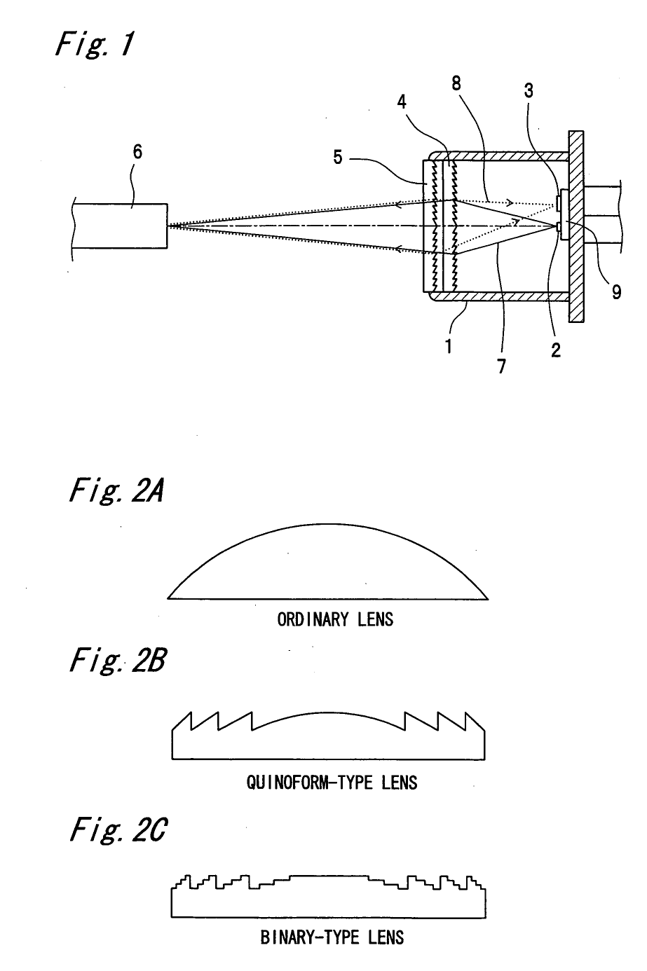

Next, the structure and optical characteristics of DOE lens 4 and 5 used in the first embodiment will be described with reference to FIGS. 2A, 2B and 2C. FIG. 2A shows an ordinary lens. On the other hand, FIG. 2B shows a diffractive optical element lens called quinoform-type DOE lens. The quinoform-type DOE lens has a shape obtained by combining the portions cut out from a lens at different heights of its cross section. FIG. 2C shows a diffractive optical element lens called binary-type DOE lens. The diffractive-type DOE lens has a shape obtained by approximating the curved and sloping surfaces of a quinoform-type lens in a staircase shape. In the present invention, binary-type DOE lenses are used for both DOE lenses 4 and 5. Alternatively quinoform-type lenses can be used.

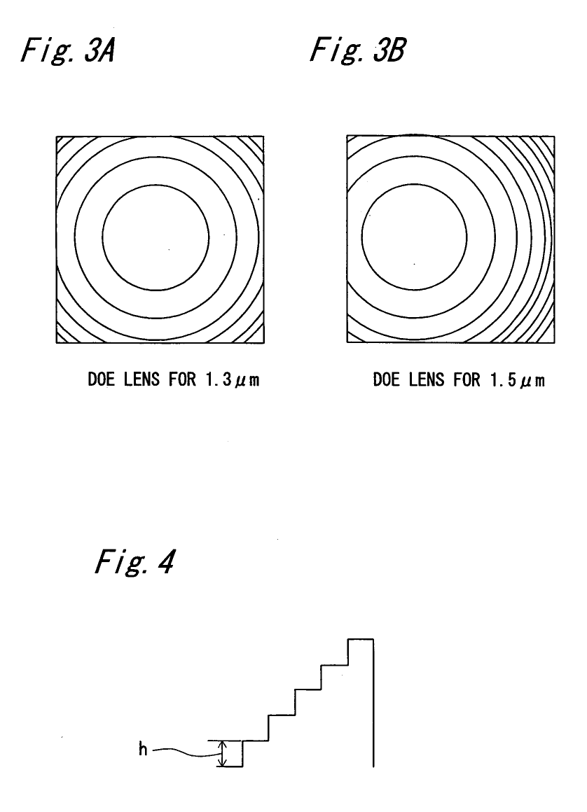

FIGS. 3A and 3B are respectively front views of DOE lens 4 for 1.3 μm and DOE lens 5 for 1.55 μm. As shown in FIGS. 3A and 3B, rings of the diffraction gratings are seen in both DOE lenses 4 and 5. Also, as clear from FIG. 3B, the central axis of DOE lens 5 for 1.55 μm is made eccentric so that the optical axis of light 8 for 1.55 μm should incline. Therefore, the rings of the diffraction grating are shifted outside from the center of the lens.

Next, the characteristics of the binary-type DOE lenses 4 and 5 having staircase-shaped diffractive surfaces of optical elements and wavelength selectivity will be described.

As shown in FIG. 4, the step height h in both DOE lenses can be defined by the height of each step on the staircase-shaped diffractive surfaces of optical elements.

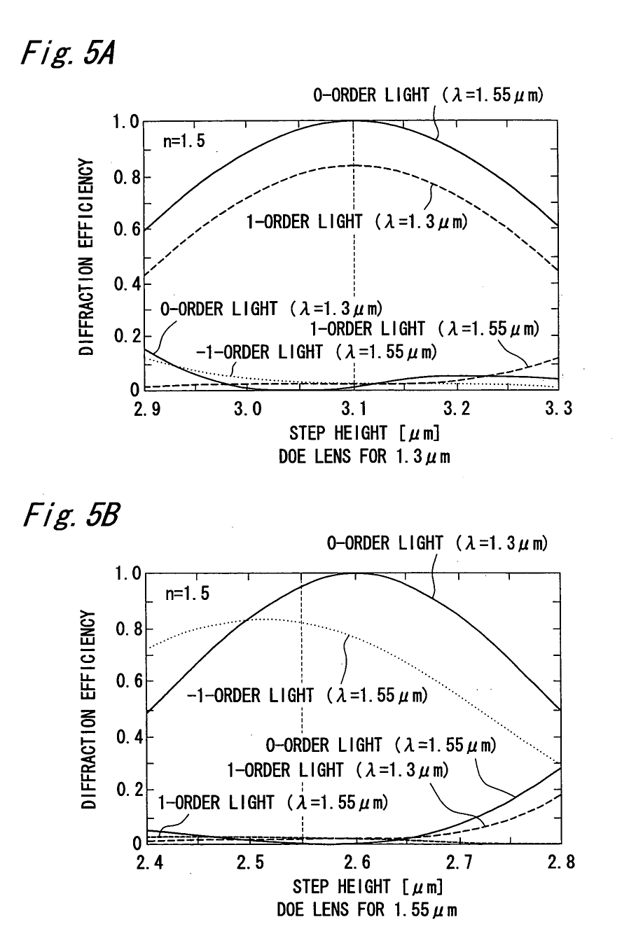

FIGS. 5A and 5B are graphs showing the dependence of the diffraction efficiency of light of order 0 and diffracted light of order +1 on the step height h in DOE lens 4 for 1.3 μm and DOE lens 5 for 1.55 μm respectively (relationship between diffraction efficiency and the step height h). Here, both DOE lens have 6 binary steps. In the computation for these graphs, the refractive indices of DOE lenses 4 and 5 are both-1.5.

In the graph for DOE lens 4 for 1.3 μm shown in FIG. 5A, the range of the step height h is from 2.9 to 3.3 μm. As seen from this graph, if the step height h is about 3.1 μm, light 8 of wavelength 1.55 μm all (100%) becomes 0-order light. That is, DOE lens 4 for 1.3 μm functions as a parallel plane plate for light 8 of 1.55 μm. Also, about 80% of light 7 of wavelength 1.3 μm becomes 1st-order diffracted light. That is, DOE lens 4 for 1.3 μm functions as a lens for light 7 of wavelength 1.3 μm. Therefore, DOE lens 4 for 1.3 μm having 6 binary steps acts as a lens for light 7 of wavelength 1.3 μm and acts as a parallel plane plate for light 8 of wavelength 1.55 μm, if the step height h is set at 3.1 μm. Therefore, the desired function described above can be achieved.

On the other hand, in the graph for DOE lens 5 for 1.55 μm shown in FIG. 5B, the range of the step height h is from 2.4 to 2.8 μm. As seen from this graph, if the step height h is about 2.55 μm, about 95% of light 7 of wavelength 1.3 μm becomes 0-order light. That is, DOE lens 5 for 1.55 μm functions as a parallel plane plate for light 7 of 1.3 μm. Also, about 80% of light 8 of wavelength 1.55 μm becomes diffracted light of order −1. That is, DOE lens for 1.55 μm functions as a lens for light 8 of wavelength 1.55 μm. Therefore, DOE lens 5 for 1.55 μm having 6 binary steps acts as a lens for light 8 of wavelength 1.55 μm and acts as a parallel plane plate for light 7 of wavelength 1.3 μm, if the step height h is set at 2.55 μm. Therefore, the desired function described above can be obtained.

The inventers of the present invention found out that the overlap of the diffraction characteristics for light 7 of wavelength 1.3 μm and for light 8 of wavelength 1.55 μm depended on the number of binary steps and that DOE lenses 4 and 5 had wavelength selectivity for light 7 of wavelength 1.3 μm and for light 8 of wavelength 1.55 μm if the step height h was set as described above. In this way, by obtaining a single lens that approximately attains both the diffraction peak for 0-order light and the diffraction peak for light of order +1 or −1, an optical transmission module in accordance with the first embodiment has a great advantage that reduces the fluctuation of diffraction efficiency due to setting errors such as fluctuation of wavelength, dispersion of the angle of incidence to a DOE, errors on DOE production, changes in the refractive index.

As described above, in an optical transmission module in accordance with the first embodiment, only the DOE lens 5 for 1.55 μm that diffracts light 8 of wavelength 1.55 μm received by photodiode 3 is made eccentric. However, conversely, only the DOE lens 4 for 1.3 μm that diffracts light 7 of wavelength 1.3 μm radiated by laser diode 2 may be made eccentric, or both lenses may be made eccentric in the directions opposite to each other. The optimal value of the step height h depends on the index of refraction of the material of DOE lenses 4 and 5. For example, if silicon is used for the material, the index n of refraction is 3.5. The optimal value of the step height h is inversely proportionate to n−1, so that the optimal value of h in this case is ⅕ of the optimal value for n=1.5((1.5-1)/(3.5-1)=⅕).

If laser diode 2 and photodiode 3 are placed near to each other, part of an electric signal applied to laser diode 2 may leak to the circuit that extracts an electric signal from photodiode 3, so that there is a possibility of false recognition or determination of the signal. However, this problem can be resolved by canceling out the electric signal from photodiode 3 with the electric signal applied to laser diode 2.

An optical transmission module in accordance with the first embodiment has a fewer number of components than prior optical transmission modules, and laser diode 2 and photodiode 3 are not separated from each other in the perpendicular directions, so that there is an advantage that the size becomes compact. Further, light of one wavelength can be converged and bent without affecting light of another wavelength, so that freedom of optical design is increased, and the coupling efficiency between the optical transmission module and the optical fiber can be raised.

(Second Embodiment)

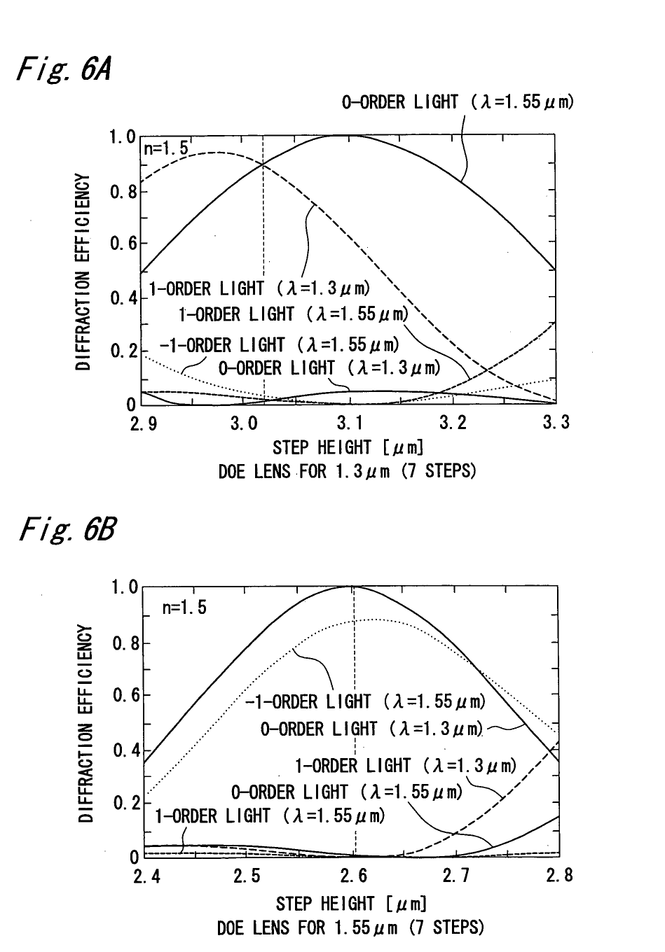

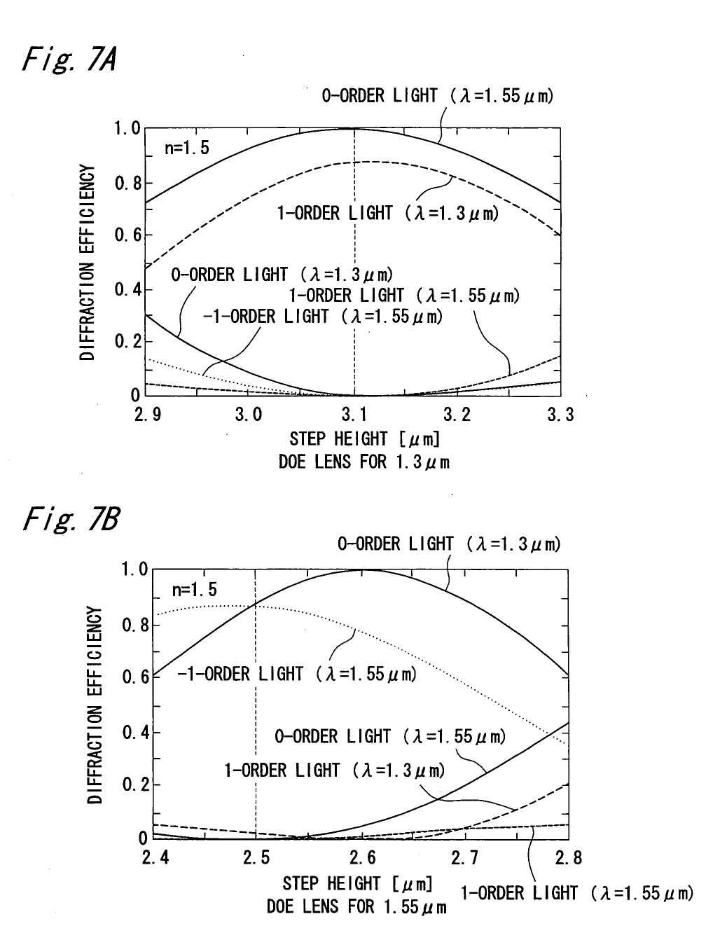

A second embodiment of the present invention will be described in the following with reference to FIGS. 6A and 6B and FIGS. 7A and 7B. An optical transmission module in accordance with the second embodiment has many common aspects with an optical transmission module in accordance with the first embodiment. Therefore, in order to avoid redundancy, only those points different from the first embodiment will be mainly described.

In an optical transmission module in accordance with the second embodiment, the number of binary steps in DOE lens 4 for 1.3 μm and DOE lens 5 for 1.55 μm is set at a value different from the value in an optical module in accordance with the first embodiment so that diffraction efficiency can be improved. The other points are the same as in the first embodiment.

FIGS. 6A and 6B are graphs showing the dependence of the diffraction efficiency of light of order 0 and diffracted light of order ±1 on the step height h in DOE lens 4 for 1.3 μm and DOE lens 5 for 1.55 μm respectively in the case of the number of binary steps being 7. In the graphs of FIGS. 6A and 6B, the range of the step height h is the same as in FIGS. 5A and 5B.

As seen from FIG. 6A, in the case of the number of binary steps of DOE lens 4 for 1.3 μm being 7., the value of h that attains the peak for 0-order light of light 8 of wavelength 1.55 μm is shifted from the value of h that attains the peak for 1st-order diffracted light of light 7 of wavelength 1.3 μm. However, as seen from FIG. 6B, in DOE lens 5 for 1.55 μm, the value of h that attains the peak for 0-order light of light 7 of wavelength 1.3 μm agrees with the value of h that attains the peak for diffracted light of order −1 of light 8 of wavelength 1.55 μm. Further, the peak value of diffraction efficiency for diffracted light of order −1 of light 8 of wavelength 1.55 μm is rising to almost 90%.

FIGS. 7A and 7B are graphs showing the dependence of the diffraction efficiency of 0-order light and diffracted light of order +1 on the step height h in DOE lens 4 for 1.3 μm and DOE lens 5 for 1.55 μm respectively in the case of the number of binary steps being 5. In the graphs FIGS. 7A and 7B, the range of the step height h is the same as in FIGS. 6A and 6B. As seen from FIGS. 7A and 7B, in the case of the number of binary steps being 5, these graphs show very similar trends and results as the graphs in the case of the number of binary steps being 6 shown in FIGS. 5A and 5B.

The following Table 1 summarizes the relationship between the number of steps and the diffraction efficiency based on the results obtained above.

TABLE 1
Relation between the number of binary steps and diffraction efficiency

| DOE | | | | | | | | | | | |
|---|---|---|---|---|---|---|---|---|---|---|---|
| lens | | 4 steps | | 5 steps | | 6 steps | | 7 steps | | 8 steps | |
| For | Diffraction | 80% | X | 100% | Ø | 100% | Ø | 90% | □ | 85% | X |
| 1.3 μm | efficiency | | | | | | | | | | |
| | of order 0 | | | | | | | | | | |
| | (1.55 μm) | | | | | | | | | | |
| | Diffraction | 80% | | 85% | | 84% | | 90% | | 80% | |
| | efficiency | | | | | | | | | | |
| | of order 1 | | | | | | | | | | |
| | (1.3 μm) | | | | | | | | | | |
| For | Diffraction | 80% | X | 85% | X | 95% | □ | 100% | Ø | 90% | □ |
| 1.55 μm | efficiency | | | | | | | | | | |
| | of order 0 | | | | | | | | | | |
| | (1.3 μm) | | | | | | | | | | |
| | Diffraction | 80% | | 85% | | 82% | | 88% | | 90% | |
| | efficiency | | | | | | | | | | |
| | of order −1 | | | | | | | | | | |
| | (1.55 μm) | | | | | | | | | | |

As seen from Table 1, for DOE lens 4 for 1.3 μm, the number of binary steps is preferred to be from 5 to 7, and particularly 5 or 6 is most preferred. For DOE lens 5 for 5 for 1.55 μm, the number of binary steps is preferred to be from. 6 to 8, and particularly 7 is most preferred. Therefore, in an optical transmission module in accordance with the first embodiment, if the number of binary steps is 5 or 6 for DOE lens 4 for 1.3 μm, and if the number of binary steps is 7 for DOE lens 5 for 1.55 μm, then the highest coupling efficiency can be obtained.

An optical transmission module in accordance with the second embodiment optimizes the number of binary steps in DOE lens 4 for 1.3 μm and laser diode 2 and DOE lens 5 for 1.55 μm and photodiode 3, in addition to the fact that it has the same action and effects as an optical transmission module in accordance with the first embodiment. Therefore, it raises the efficiency of optical coupling.

(Third Embodiment).

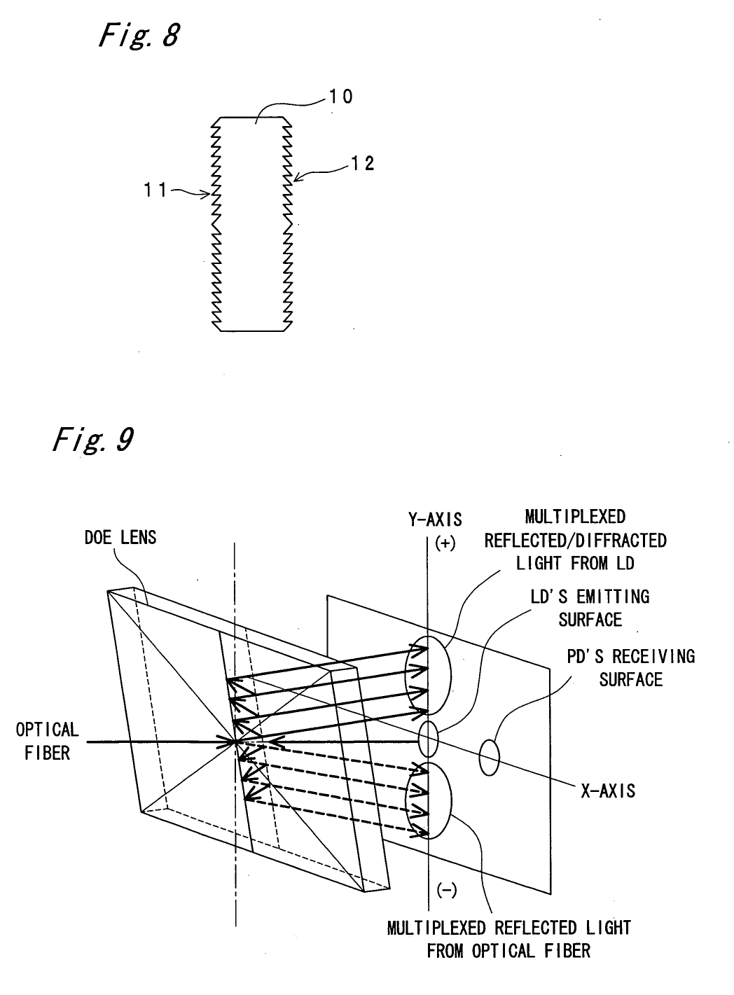

A third embodiment of the present invention will be described in the following with reference to FIG. 8. An optical transmission module in accordance with the third embodiment has many common aspects with an optical transmission module in accordance with the first embodiment. Therefore, in order to avoid redundancy, only those points different from the first embodiment will be mainly described.

As seen from FIG. 8, an optical transmission module in accordance with the third embodiment is equipped with an integrated DOE lens 10 in place of DOE lens 4 for 1.3 μm and DOE lens. 5 for 1.55 μm. This integrated lens DOE lens 10 has a structure that a surface 11 of a DOE lens for 1.3 μm and a surface 12 of a DOE lens 12 for 1.551 μm are formed respectively on the front and back surfaces of a single plate. The other aspects are similar to those of an optical transmission module of in accordance with the first embodiment. This integrated DOE lens may be produced by laminating an individually produced DOE lens for 1.3 μm and DOE lens for 1.55 μm with an adhesive.

An optical transmission module in accordance with the third embodiment uses an integrated lens 10, in addition to the same action and effects as an optical transmission module in accordance with the first embodiment. Therefore, the number of optical components becomes smaller, and the size becomes more compact.

(Fourth Embodiment)

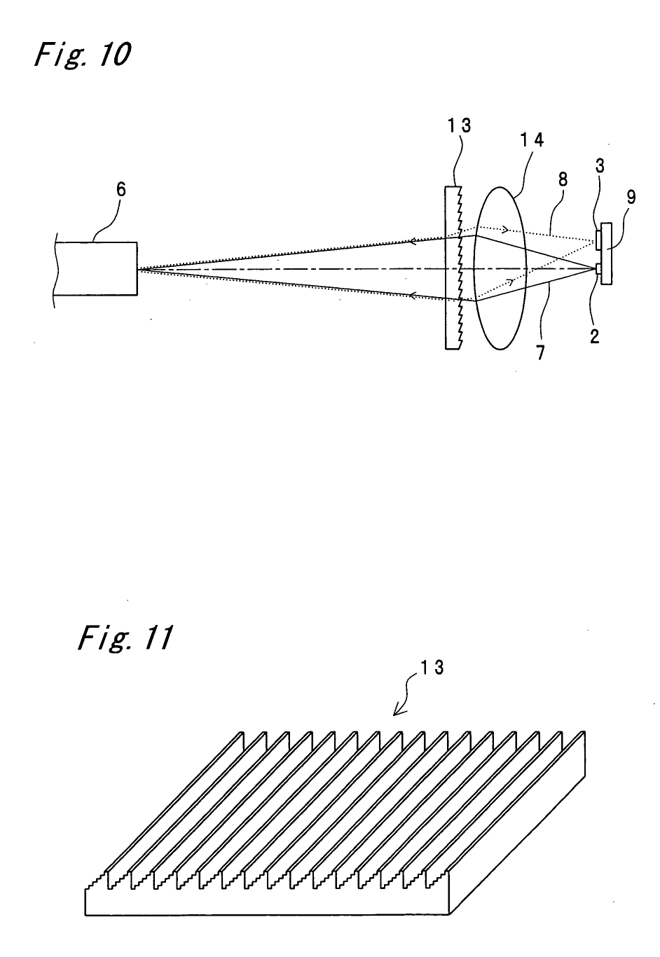

A fourth embodiment of the present invention will be described in the following with reference to FIG. 9. An optical transmission module in accordance with the fourth embodiment has many common aspects with an optical transmission module in accordance with the first embodiment. Therefore, in order to avoid redundancy, only those points different from the first embodiment will be mainly described.

An optical transmission module in accordance with the fourth embodiment prevents cross-talk light that occurs when multiplexed reflected light between DOE lenses 4 and 5 or within DOE lenses 4 and 5 is incident on photodiode 3. The other aspects are the same as those of an optical transmission module in accordance with the first embodiment. The techniques and means of preventing the cross-talk light in the fourth embodiment will be described in the following.

Generally speaking, in an optical transmission module of the present kind, there exist light of wavelength 1.3 μm radiated from laser diode 2 and returning after reflected on one of the surfaces of DOE lenses 4 and 5, light returning after reflected and diffracted on both surfaces of one of the DOE lenses 4 and 5, and multiplexed light returning after reflected and diffracted on both surfaces of the DOE lenses 4 and 5. Therefore, light of wavelength 1.3 μm of these kinds is contained in the light emitted from optical fiber 6 besides the desired light of wavelength 1.55 μm to be detected. When such light of wavelength 1.3 μm is received by photodiode 3, this light cannot be distinguished from the light of wavelength 1.55 μm to be detected, so that errors occur in recognition or determination of a signal.

FIG. 9 shows a technique or means for preventing multiplexed reflected light of wavelength 1.3 μm from reaching photodiode 3. Here, assume that laser diode 2 and photodiode 3 are shifted in the direction of the X-axis on the plane where laser diode 2 and photodiode 3 is arranged (here called diode arrangement plane). DOE lens 4 is inclined from an original position parallel to the diode arrangement plane. Now let this inclination be such that DOE lens 4 is parallel to the X-axis and inclined from the Y-axis on the diode arrangement plane perpendicular to the X-axis.

If DOE lens 4 is arranged in this way, among the light of wavelength 1.33 μm radiated from diode 2 shown with solid lines, the light reflected on the surface of DOE lens returns to a location shifted in the direction of the Y-axis. In FIG. 9, this location is on the positive side of the Y-axis. Therefore this light of wavelength 1.3 μm does not reach photodiode 3.

On the other hand, the multiplexed reflected light of wavelength 1.3 μm (shown by dotted lines), which is mixed in light of wavelength 1.55 μm emitted from optical fiber 6 and eventually passes through DOE lens 4, reaches a location shifted in the direction of the Y-axis at its negative side. Therefore, this light of 1.3 μm does not reach photodiode 3 either. If on the contrary, DOE lens 4 is parallel to the Y-axis and inclined from the X-axis, then the multiplexed reflected light from laser diode 2 reaches a location shifted in the direction of the X-axis to the side opposite to photodiode 3. However, multiplexed reflected light from optical fiber 6 reaches a location shifted in the direction of the X-axis to the same side of photodiode 3. Therefore, photodiode 3 receives this light.

An optical transmission module in accordance with the fourth embodiment can eliminate cross-talk light due to multiple reflection, in addition to the same action and effects as an optical transmission module in accordance with the first embodiment. Therefore, accurate recognition and determination of a signal can be achieved.

(Fifth Embodiment)

A fifth embodiment of the present invention will be described in the following with reference to FIGS. 10 and 11. An optical transmission module in accordance with the fifth embodiment has many common aspects with an optical transmission module in accordance with the first embodiment. Therefore, in order to avoid redundancy, only those points different from the first embodiment will be mainly described.

As shown in FIG. 10, an optical transmission module in accordance with the fifth embodiment uses a combination of a wavelength-separating DOE 13 (wavelength-separating diffractive optical element) for wavelength separation and an ordinary lens 14. The other aspects are the same as those of an optical transmission module in accordance with the first embodiment.

Lens 14 converges (optically couples) light 7 of 1.3 μm radiated from laser diode 2 onto optical fiber 6 and also helps light 8 of wavelength 1.55 μm emitted from optical fiber 6 to be received by photodiode 3. DOE 13 is used to incline the optical axis of light 8 emitted from optical fiber 6. This wavelength-separating DOE 13 functions as a parallel plane plate for light 7 of wavelength 1.3 μm.

FIG. 11 shows the shape of the wavelength-separating DOE 13. As seen from FIG. 11., a series of parallel grooves with their triangular cross sections arranged in one direction is formed in DOE 13. Each triangular groove has minute staircase-shaped steps i.e. a binary shape as in the first embodiment. The number of binary steps is 7 as in the second embodiment. The step height of each binary step is preferably 2.6 μm if the index of refraction is 1.5.

In the example shown in FIG. 10, light 7 of wavelength 1.3 μm radiated from laser diode 2 is passed straight and light 8 of wavelength 1.55 μm received by photodiode 3 is bent. However this situation may be reversed. In that case, the number of binary steps is preferred to be 6 and the step height is preferred to be 3.1 μm if the index of refraction is 1.5.

In an optical transmission module in accordance with the fifth embodiment, the wavelength-separating DOE 13 is preferably inclined as in the fourth embodiment. Also, the arrangement of DOE 13 and lens 14 may be reversed from the order illustrated in FIG. 10. However, in the arrangement shown in FIG. 10, the distance between DOE 13 and photodiode 3 can be made longer, so that light 7 of wavelength 1.3 μm and light 8 of wavelength 1.55 μm can be further separated with a small separation angle.

An optical transmission module in accordance with the fifth embodiment uses a linear-shape diffraction grating in place of a circular-shape diffraction grating, in addition to the same action and effects as an optical transmission module in accordance with the first embodiment. Therefore, the production becomes easier, and accuracy of position may be slackened.

(Sixth Embodiment)

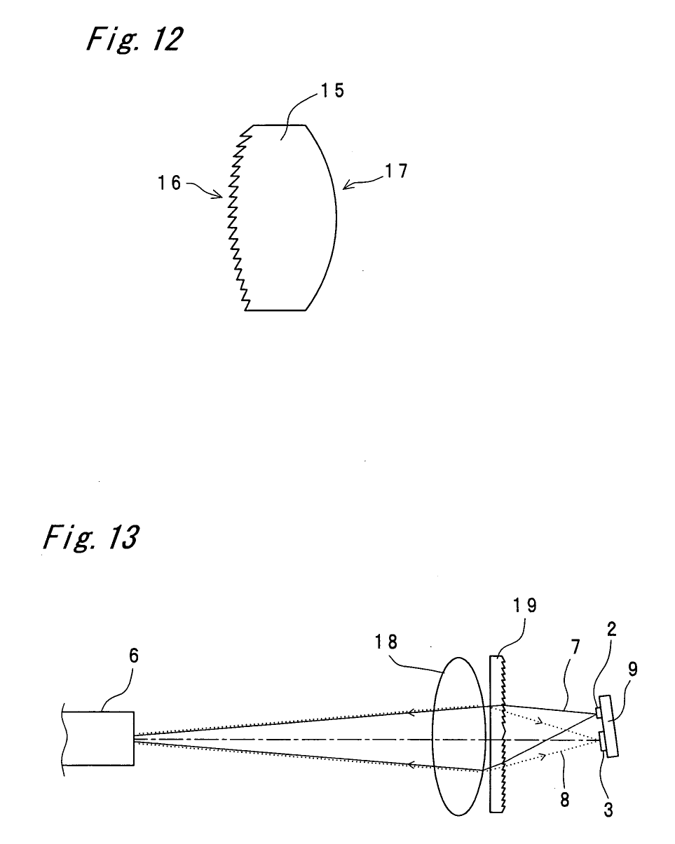

A sixth embodiment of the present invention will be described in the following with reference to FIG. 12. An optical transmission module in accordance with the fifth embodiment has many common aspects with an optical transmission module in accordance with the fifth embodiment. Therefore, in order to avoid redundancy, only those points different from the fifth embodiment will be mainly described.

As shown in FIG. 12, an optical transmission module in accordance with the sixth embodiment uses a lens 15 such that its one surface is a lens/grating surface 16 in which a series of parallel grooves with their triangular cross sections arranged in one direction is formed and the other surface is an ordinary lens surface 17. That is, lens 15 is a one obtained by integrating the wavelength-separating DOE 13 and the lens 14 in the fifth embodiment (see FIG. 10). Therefore, lens 15 has both lens effects and wavelength separation effects.

An optical transmission module in accordance with the sixth embodiment uses the integrated lens 10, in addition to the same action and effects as an optical transmission module in accordance with the fifth embodiment. Therefore, the number of optical components becomes smaller.

(Seventh Embodiment)

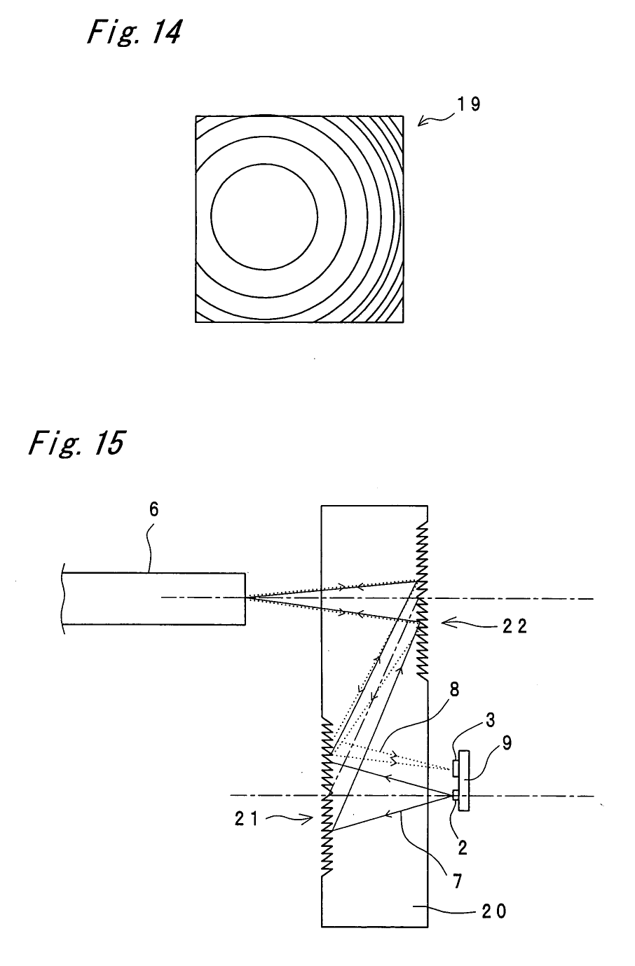

A seventh embodiment of the present invention will be described in the following with reference to FIGS. 13 and 14. An optical transmission module in accordance with the seventh embodiment has many common aspects with an optical transmission module in accordance with the first embodiment. Therefore, in order to avoid redundancy, only those points different from the first embodiment will be mainly described.

Generally, in a DOE lens having large power, the pitch of the diffraction grating becomes narrow, so that its production becomes difficult. Also there is a disadvantage that diffraction efficiency becomes lower. Therefore, as shown in FIG. 13, an optical transmission module in accordance with the seventh embodiment uses a spherical lens 18 in an optical system and an eccentric non-spherical DOE lens 19. The eccentric non-spherical DOE lens 19 performs diffraction action for light 7 of wavelength 1.3 μm, which is the oscillation wavelength of laser diode 2, and acts as a parallel plane plate for light 8 of wavelength, 1.55 μm emitted from optical fiber 6. FIG. 14 is a front view of the eccentric non-spherical DOE lens 19.

Generally, the incidence of light 7 of wavelength 1.3 μm from laser diode 2 onto optical fiber 6 requires extremely high accuracy (construction precision), so that a non-spherical lens is often used to increase efficiency as high as possible. In contrast, since the light-receiving area of photodiode 3 is large, the light-reception efficiency of an ordinary spherical lens is sufficient for photodiode 3.

Therefore, the seventh embodiment uses a DOE lens for the power obtained by subtracting the lens power required for optical coupling between optical fiber 6 and photodiode 3 from the lens power required for optical coupling between laser diode 2 and optical fiber 6 and uses a spherical lens for the remaining common power. Therefore, the DOE lens contains a non-spherical part. Also, the DOE lens is made eccentric in order to give a wavelength-separation function. In other words, the DOE lens is made to function as an eccentric non-spherical lens for wavelength 1.3 μm.

In an optical transmission module in accordance with the seventh embodiment, light 7 of wavelength 1.3 μm radiated from laser diode 2 is converged with certain power including aberration correction on non-spherical surface by the eccentric non-spherical DOE lens 19 and is emitted with an inclined optical axis. Then this light 7 of wavelength 1.3 μm is converged again by spherical lens 18 to be made incident on optical fiber 6.

On the other hand, light 8 of wavelength 1.55 μm emitted from optical fiber 6 passes straight through DOE lens 19 after being converged by spherical lens 18 and is received by photodiode 3. The substrate 9 on which laser diode 2 and photodiode 3 are installed is inclined from spherical lens 18 and DOE lens 19 so that light 7 of 1.3 μm radiated from laser diode 2 can be tilted from the optical axis connecting the center of spherical lens and optical fiber 6.

The eccentric non-spherical DOE lens 19 shown in FIG. 14 is preferred to have 6 binary steps as the DOE lens for 1.3 μm in an optical transmission module in accordance with the first embodiment. In this case, the step height of each binary step is preferable 3.1 μm if the index of refraction is 1.5. As shown in FIG. 14, the distances between rings and their adjacent rings of the grating in DOE lens 19 are not uniform, since DOE lens 19 is a non-spherical lens.

The arrangement order of spherical lens 18 and DOE lens 19 can be reversed from the arrangement order shown in FIG. 13. However, if DOE lens 19 is arranged on the side of laser diode 2 as shown in FIG. 13, there is an advantage that aberration correction effects on a non-spherical surface become higher.

Further, the eccentric non-spherical DOE lens 19 has a characteristic that its focal length varies with wavelength. Therefore, if the oscillation wavelength of laser diode 2 varies with changes in temperature and the like, there is a disadvantage that the efficiency of incidence to optical fiber 6 becomes lower with the change in the focal length. This disadvantage can be overcome by the dependence of power on wavelength inherent in spherical lens 18. Specifically, the eccentric non-spherical lens 19 has a characteristic that its power increases as the wavelength increases. This characteristic is opposite to the characteristic of an ordinary lens. Therefore, if the material of spherical lens 18 and power distribution to lenses 18 and 19 are properly set so that the combined whole power of spherical lens 18 and DOE lens 19 cannot change, then this disadvantage can be resolved.

An optical transmission module in accordance with the seventh embodiment uses a combination of the spherical lens 18 and the eccentric non-spherical lens 19, in addition to the same action and effects as an optical transmission module in accordance with the first embodiment. Therefore, the productivity of DOE lens 19 can be increased, and coupling efficiency can also be increased. Further, spherical lens 18 supports the sharing of photodiode coupling and diode coupling, so that the number of components can be reduced.

(Eighth Embodiment)

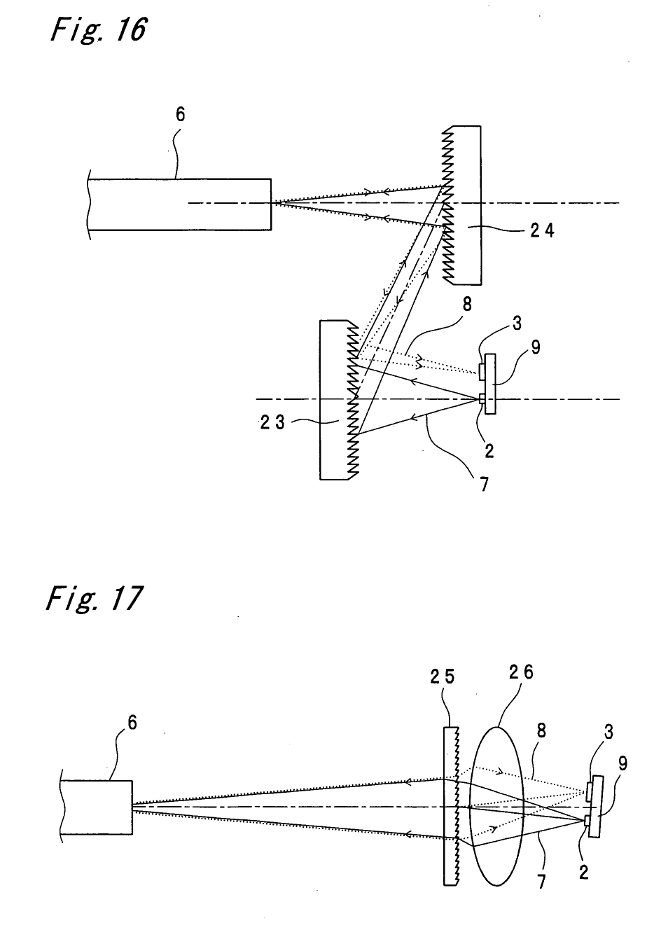

An eighth embodiment of the present invention will be described in the following with reference to FIGS. 15 and 16. An optical transmission module in accordance with the eighth embodiment has many common aspects with an optical transmission module in accordance with the first embodiment. Therefore, in order to avoid redundancy, those points different from the first embodiment will be mainly described.

As shown in FIG. 15, an optical transmission module in accordance with the eighth embodiment uses a reflection-type DOE 20 (DOE mirror). In the reflection-type DOE 20, a DOE mirror 21 for 1.3 μm is formed on one part (on the optical fiber side) of a plate made of an optical material, and a DOE mirror 22 for 1.55 μm is formed on another part (on the diode side). Both DOE mirrors 21 and 22 consist in a lens-shaped diffraction grating with reflective coatings on the plate. DOE mirrors 1 and 22 have diffraction action for light of one wavelength and have parallel reflection action for another wavelength. Substantially, these mirrors have the similar functions as the DOE lenses 4 and 5 in the first embodiment.

In an optical transmission module in accordance with the eighth embodiment, light 7 of wavelength 1.3 μm radiated from laser diode 2 is bent and reflected by DOE mirror 21 for 1.3 μm to be directed to DOE mirror 22 for 1.55 μm. This light 7 of wavelength 1.3 μm is then planarly reflected by DOE mirror 22 for 1.55 μm and after passing through DOE 20 (plate), is made incident on optical fiber 6. On the other hand, light 8 of wavelength 1.55 μm emitted from optical fiber 6 is bent and reflected by DOE mirror 22 for 1.55 μm, after entering the reflection-type DOE 20, to be directed to DOE mirror 21 for 1.3 μm. This light 8 of wavelength 1.55 μm is then planarly reflected by DOE mirror 21 for 1.3 μm and received by photodiode 3 after passing through the reflection-type DOE 20 (plate).

FIG. 16 shows a variant of optical transmission modules using a reflection-type DOE. As shown in FIG. 16, in this optical transmission module, a DOE mirror 23 for 1.3 μm and a DOE mirror 24 for 1.55 μm are formed separately from each other. Therefore, in this optical transmission module, none of the light 7 and 8 propagates within the optical material, but both propagate within space. The optical paths of light 7 and 8 are the same as in the optical transmission shown in FIG. 15.

An optical transmission module in accordance with the eighth embodiment has the same action and effects as an optical transmission module in accordance with the first embodiment. In a transmission-type DOE, some diffracted light reflected on the surface occurs, so that a device for preventing this light from entering the photodiode 3 is necessary. However, if a reflection-type DOE 20 or DOE mirrors 23 and 24 are used as in an optical transmission module in accordance with the eighth embodiment, there is an advantage that such unwelcome light does not occur.

(Ninth Embodiment)

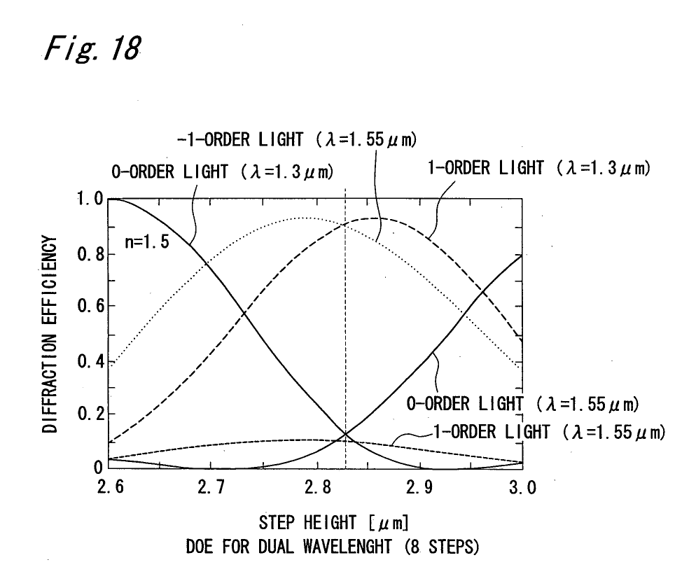

An eighth embodiment of the present invention will be described in the following with reference to FIGS. 17 and 18. As described so far, in an optical-transmission module in accordance with any one of the first through eighth embodiment, a DOE diffracts light of one wavelength and does not diffract light of another wavelength. In contrast, in an optical transmission module in accordance with the ninth embodiment, a DOE diffracts light of one wavelength with order 1 and diffracts light of another wavelength with order −1. That is, the optical transmission module has diffraction action of different diffraction orders.

FIG. 17 shows an example of optical transmission modules that have diffraction action of different diffraction orders. The basic configuration of this optical transmission module is the same as in an optical transmission module in accordance with the fifth embodiment. As shown in FIG. 17, an optical transmission module in accordance with the ninth embodiment uses a wavelength-selective DOE 25 and an ordinary lens 26. Here wavelength-selective DOE 25 diffracts light of wavelength 7 with order +1, and diffracts light 8 of wavelength 1.55 μm with order −1.

Light 7 of wavelength 1.3 μm radiated from laser diode 2 is converged and bent by lens 26, diffracted by DOE 25 with order +1, bent downward on the sheet of FIG. 17, and made incident on optical fiber 6. On the other hand, light 8 of wavelength 1.55 μm is diffracted by DOE 25 with order −1, bent toward upward on the sheet of FIG. 17, and converged on photodiode 3 by lens 26. In this optical transmission module, the substrate 9 on which laser diode 2 and photodiode 3 are installed is inclined so that the optical axis of light 7 of wavelength 1.3 μm radiated from photodiode 7 should be perpendicular to the surface of substrate 9.

The wavelength-selective DOE 25 having different diffraction orders depending on wavelength can be realized by a DOE having a binary-shape DOE of 8 binary steps.

FIG. 18 is a graph showing the relationship between the binary step height and diffraction efficiency for the wavelength-selective DOE 25 (DOE for dual wavelength) having 8 binary steps.

As seen from FIG. 18, if the height of each binary step is set at 2.83 μm in the case of the refractive index being 1.5, then diffraction efficiency 90% is obtained for both diffracted light of order +1 for light 7 of wavelength 1.3 μm and diffracted light of order −1 for light 8 of wavelength 1.55 μm. Here, the diffracted light of order −1 is the first-order diffracted light with a negative diffraction angle, i.e. the diffracted light of order −1 diffracts toward the opposite side of the diffracted light of order +1 from the optical axis of the incident light. Therefore, the wavelength-selective DOE having 8 binary steps can achieve the desired function described above, if the height of each binary step is set at 2.83 μm in the case of the refractive index being 1.5.

An optical transmission module in accordance with the ninth embodiment uses the wavelength-selective DOE 25 that generates diffracted light of diffraction orders having opposite signs depending on wavelength, so that light 7 and 8 can be diffracted toward opposite sides from each other. Therefore, light 7 and 8 of different wavelengths can be widely separated with smaller diffraction angles. Further, the production of the wavelength-selective DOE 25 is easy.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An optical transmission module which sends and receives light transmitted bi-directionally through an optical fiber, said optical transmission module comprising:
a light source which radiates light of a first wavelength;
a light-receiving section which receives light of a second wavelength emitted from said optical fiber; and
a binary-type diffractive optical element with a staircase-shaped diffractive surface, which has principal diffractive action of different diffraction orders respectively for the light of said first wavelength and the light of said second wavelength, wherein
said diffractive optical element separates the first optical axis passing from said light source to said optical fiber and the second optical axis passing from said light-receiving section to said optical fiber.

2. The optical transmission module according to claim 1, wherein said diffractive optical element bends one of the light of said first wavelength and the light of said second wavelength by a diffraction action and does not bend the other light by performing diffraction action of order 0.

3. The optical transmission module according to claim 1, wherein said diffractive optical element diffracts the light of said first wavelength and the light of said second wavelength with diffraction orders of mutually opposite signs, so that the light of said first wavelength and the light of said second wavelength are bent toward mutually opposite directions.

4. The optical transmission module according to claim 1, wherein said diffractive optical element has lens action which converges the light of first wavelength from said light source onto said optical fiber, or alternatively has lens action which converges the light of said second wavelength from said optical fiber onto said light-receiving section, and the center of the lens is made eccentric from a straight line passing from said light source to said optical fiber or alternatively from a straight line passing from said optical fiber to said light-receiving section.

5. The optical transmission module according to claim 1, further comprising a lens which converges and bends light from said light source toward said optical fiber and converges and bends light from said optical fiber toward said light-receiving section, wherein
said diffractive optical element has a grating shape uniform in one direction on an incidence surface which receives light from said light source.

6. The optical transmission module according to claim 1, wherein said diffractive optical element is a transmission-type diffractive optical element.

7. The optical transmission module according to claim 1, wherein said diffractive optical element is a reflection-type diffractive optical element.

8. The optical transmission module according to claim 2, wherein one of said first wavelength and said second wavelength is a wavelength of a 1.3 μm band while the other is a wavelength of a 1.55 μm band, the number of steps in the staircase of said diffractive optical element being equal to or greater than 5 and equal to or less than 8.

9. The optical transmission module according to claim 3, wherein one of said first wavelength and said second wavelength is a wavelength of a 1.3 μm band while the other is a wavelength of a 1.55 μm band, the number of steps in the staircase of said diffractive optical element being 8.

10. The optical transmission module according to claim 4, wherein said diffractive optical element comprises a first diffractive optical element and a second diffractive optical element, said first diffractive optical element having lens action that converges the light of said first wavelength from said light source onto said optical fiber and having transmission action for the light of said second wavelength from said optical fiber, and said second diffractive element having lens action that converges the light of said second wavelength from said optical fiber onto said light-receiving section and having transmission action for the light of said first wavelength from said light source.

11. The optical transmission module according to claim 4, further comprising a lens which converges and bends light from said light source toward said optical fiber and converges and bends light from said optical fiber toward said light-receiving section, wherein said diffractive optical element has lens action that converges and bends the light of said first wavelength from said light source onto said optical fiber and has transmission action for the light of said second wavelength from said optical fiber, or alternatively
said diffractive element has lens action that converges the light of said second wavelength from said optical fiber onto said light-receiving section and has transmission action for the light of first wavelength from said light source.

12. The optical transmission module according to claim 10, wherein said first diffractive optical element and said second diffractive element are respectively formed on two surfaces of a single member facing to each other in opposite directions.

13. The optical transmission module according to claim 6, wherein said transmission-type optical element is positioned so as to be inclined from an axis perpendicular to the axis connecting said light source and said light-receiving section, on a plane on which said light source and said light-receiving section are disposed.

14. The optical transmission module according to claim 5, wherein said diffractive optical element is formed on a surface of said lens.

15. The optical transmission module according to claim 11, wherein said diffractive optical element has eccentric non-spherical action as said lens action.

16. The optical transmission module according to claim 1, wherein said light source and said light-receiving section are arranged on a single substrate, said substrate and said diffractive optical element being housed in a sealed single package.

17. The optical transmission module according to claim 16, wherein an electric signal sent to said light source and a received electric signal from said light-receiving section cancel to each other out, so that mutual electric cross talk is eliminated.

18. The optical transmission module according to claim 10, wherein one of said first wavelength and said second wavelength is a wavelength of a 1.3 μm band while the other is a wavelength of a 1.55 μm band, the number of steps in the staircase of said first diffractive optical element being 5 or 6, and the number of steps in the staircase of said second diffractive optical element being 7.
